(19) United States
(12) Patent Application Publication
(10) Pub. No.: US 2008/0210214 A1
(43) Pub. Date: Sep. 4, 2008

(54) OUTDOOR GRILL COVER

(76) Inventor: Mark Wade, Newaygo, MI (US)

Correspondence Address: COHEN & GRIGSBY, P.C., 11 STANWIX STREET, 15TH FLOOR, PITTSBURGH, PA, 15222, US

(21) Appl. No.: 12/039,108

(22) Filed: Feb. 28, 2008

Related U.S. Application Data
(63) Continuation-in-part of application No. 12/030,990, filed on Feb. 14, 2008.
Application No. 12/030,990 is a continuation-in-part of application No. 11/943,032, filed on Nov. 20, 2007.
(60) Provisional application No. 60/892,261, filed on Mar. 1, 2007.

(51) Int. Cl. A47J 37/00; A47J 37/06

(52) U.S. Cl. 126/25 R; 126/299 R; 126/1 F

(57) ABSTRACT

A cover (10) for use with outdoor grills includes an inner insulating layer (14) and an outer protective layer (16).

### RELATED APPLICATION

This application is a Continuation-In-Part of copending U.S. patent application Ser. No. 12/030,990 filed Feb. 14, 2008 which is a Continuation-In-Part of copending U.S. patent application Ser. No. 11/943,032 filed Nov. 20, 2007, which claims priority to U.S. Provisional Patent Application No. 60/892,261 filed Mar. 1, 2007.

### BACKGROUND OF THE INVENTION

1. Field of the Invention

The presently disclosed invention relates to covers for outdoor grills and, more specifically, to insulated covers for improving the thermal efficiency of outdoor grills.

2. Description of the Prior Art

Outdoor cooking grills have been used for many years. Examples are shown in U.S. Pat. Nos. 2,233,463; 5,918,536; and 5,934,184. Such grills typically include one or more racks that are located in a metal housing. The racks are enclosed by a metal hood that is pivotally connected to the housing.

Generally, the metal housing and hood have high thermal conductivity which makes the grills relatively fuel inefficient. Thermal inefficiencies of outdoor grills are especially pronounced when used in colder ambient conditions. This difficulty is aggravated by the necessity of opening the grill hood to observe and prepare the food. All of these difficulties are further aggravated in all ambient temperatures when the grill is exposed to windy conditions.

Such grills are used with various fuel sources. Although charcoal is still widely used, a more recent adaptation has been the use of propane and natural gas. However, in view of the steadily rising cost of propane and natural gas, there has been a need to improve the energy efficiency of outdoor grills that use those fuels.

Thermally efficient hoods for gas grills have been suggested in the past. Examples of hoods with thermal insulation, thermal isolation and thermal reflective properties are shown in U.S. Pat. Nos. 4,434,781; 5,582,094; and 6,276,356. However, these hoods are of rigid construction or have rigid insulation. This has made them bulky to store and also tends to impair the thermal efficiency of the hood. Also, formed, rigid hoods are not readily adaptable to different brands and models of gas grills or to design modifications of gas grills from year-to-year. Thus, retailers are required to maintain a large inventory of styles and sizes of such hoods. A disadvantage for users of such grills is that it is unlikely that they could continue to use the hood if they replaced their gas grill with a different make or model of grill. Still another disadvantage of such hoods was that they could not limit heat loss that occurred between the junction of the base housing and the hood of the grill.

Accordingly, there was a need for a grill that offered improved thermal efficiency, but that also could be applied to a variety of makes and models of gas grills. There was also a need for a grill with improved thermal efficiency for the junction of the base and the hood. Particularly, there was a need in the prior art to improve the thermal efficiency of outdoor grills that are used under adverse conditions of high winds and low ambient temperatures.

### SUMMARY OF THE INVENTION

In accordance with the subject invention, a grill cover includes at least one insulation layer and at least one protective layer. Preferably, the grill cover extends over the top surface of the grill and, more preferably, extends to a location that is vertically below the junction formed between a base of the grill and a hood of the grill.

An object of the presently disclosed invention is to provide thermal insulation that can be conveniently applied to a variety of existing outdoor grills.

A further object of the invention is to provide thermal insulation for a gas grill that addresses potential heat loss at the gap or junction between the grill base and a grill hood that is pivotally connected to the base.

A further object of the invention is to provide thermal insulation for an outdoor grill where said insulation is resistant to open flames and tolerant of high temperatures—particularly temperatures above 600° F.

A further object of the invention is to provide thermal insulation for an outdoor grill where such insulation is weather resistant so that it is protective of itself and, preferably, also protective of the grill.

A further object of the invention is to reduce the time necessary to preheat an outdoor grill to a selected temperature and to maintain the selected temperature under a variety of ambient temperatures and wind conditions.

A still further object of the invention is to reduce the overall time for cooking a meal on an outdoor grill and reduce the time for an outdoor grill to recover a selected temperature after the grill cover has been opened and then reclosed during the cooking process.

Another object of the invention is to provide a cover between the grill hood and a handle that is connected to the grill hood such that the cover shields against an operator inadvertently touching the grill hood when opening and closing the grill hood.

In colder climates, the presently disclosed grill cover will effectively extend the grilling season by affording the ability to grill outdoors in cold or windy ambient conditions.

Advantageously, the disclosed grill cover will reduce consumption of propane and natural gas and, consequently, reduce the emission of air pollutants resulting from the combustion of propane and natural gas.

Other objects and advantages of the presently disclosed invention will become apparent to those skilled in the art as a description of several embodiments of the presently disclosed invention proceeds.

### BRIEF DESCRIPTION OF THE DRAWINGS

Several preferred embodiments of the presently disclosed invention are shown in the accompanying drawings wherein:

FIG. 1 shows a typical gas grill having a hood that is pivotally connected to a housing and with the disclosed cover applied thereon;

FIG. 2 shows an embodiment of a flat-style grill cover as herein disclosed;

FIG. 2A shows a cross-section of the grill cover of FIG. 2 taken along the lines 2A-2A of FIG. 2;

FIG. 2B shows an alternative embodiment of the grill cover of FIGS. 2 and 2A;

FIGS. 3A-3E illustrate an embodiment of a fitted-style grill cover as herein disclosed;

FIG. 3F shows an alternative embodiment of the grill cover of FIGS. 3A-3E;

FIG. 4 shows an alternative embodiment of the disclosed flat-style grill cover having two straps for securing the cover to the grill;

FIG. 4A shows a cross-section of the grill cover of FIG. 4 taken along the lines 4A-4A of FIG. 4;

FIG. 4B shows an alternative embodiment of the grill cover of FIGS. 4 and 4A;

FIG. 5 shows another alternative embodiment of the disclosed flat-style grill cover having a handle thereon;

FIG. 5A shows a cross-section of the grill cover of FIG. 5 taken along the lines 5A-5A of FIG. 5;

FIG. 5B shows an alternative embodiment of the grill cover of FIGS. 5 and 5A;

FIG. 6 shows another alternative embodiment of the disclosed flat-style grill cover having a viewing window therein;

FIG. 7 is a graph that depicts the results of test number 1 described in the specification;

FIG. 8 is a graph that depicts the results of test number 2 described in the specification;

FIG. 9 is a graph that depicts the results of test number 3 described in the specification.

FIG. 10 is a graph that depicts the results of test number 4 described in the specification;

FIG. 11 is a graph that depicts the results of test number 5 described in the specification;

FIG. 12 is a plan view of an alternative embodiment of the grill cover that includes an extension section; and

FIG. 13 is a perspective view of the grill cover shown in FIG. 12 as applied to a grill.

### DESCRIPTION OF A PRESENTLY PREFERRED EMBODIMENT

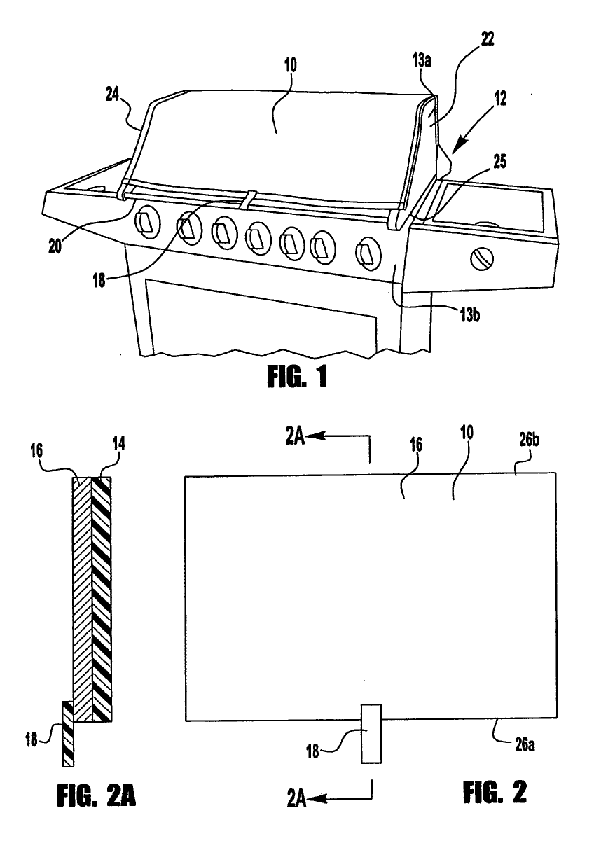

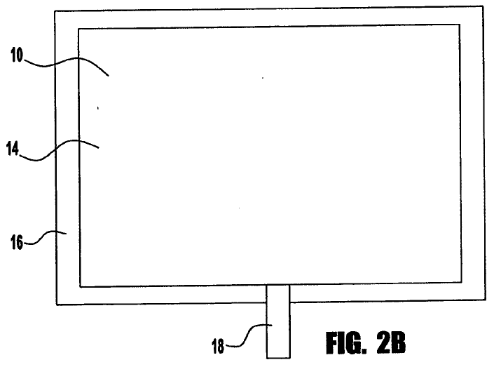

FIG. 1 shows an embodiment of the disclosed cover 10 as applied to a typical outdoor gas grill 12 having a hood 13a that is pivotally connected to a housing 13b. As further shown in FIGS. 2 and 2A, cover 10 is a flat style cover wherein an inner layer 14 of insulating material is secured to an outer protective layer 16. Cover 10 is in the shape of a flexible flat panel that is sized to lay over and cover the top of the grill hood 13a from front to back. Preferably, inner layer 14 is 18 oz. plain weave fiberglass that is heat resistant to 1000° F. and that is heat treated to remove organic material. Other equivalent material could also be used for inner layer 14. The outer protective layer 16 is 3 mm. aluminum. Alternatively, silicon rubber such as #1715-2 Sil Rub or equivalent that is heat resistant to at least 600° F. could be used for some embodiments. Vinyl or other equivalent material could also be used for the outer protective layer 16.

Cover 10 can further include a strap 18 that is secured to a handle 20 of grill 12. Preferably, strap 18 is made of fiberglass material that is sewn to protective layer 16. Alternatively, strap 18 can be made of a hook and loop material so that the cover can be easily secured to and removed from handle 20.

Preferably, inner layer 14 is bonded to outer protective layer 16 with an adhesive that, in its cured state, is heat resistant to temperatures of at least 900° F. In addition, to retard fraying of the edges of inner layer 14 and outer protective layer 16, the assembly of inner layer 14 and protective layer 16 are sewn around the perimeter with thread that is heat resistant to temperatures of at least 900° F. The thread, which can also be used to sew strap 18 to protective layer 16, can be fiberglass, nylon or equivalent material. As an alternative to adhesive bonding, inner layer 14, protective layer 16 and strap 18 can be secured together by nylon or fiberglass thread that is heat resistant to temperatures of at least 900° F. Alternatively, those components can be secured together by mechanical fasteners such as staples or rivets. Alternatively, the layers 14 and 16 and strap 18 may be detachably connected in a modular assembly by hook and loop material, fabric snaps, or equivalent fasteners.

As an alternative to grill cover 10 as shown in FIGS. 1 and 2, the flat-style grill cover can be made wider so that it drapes over the ends 22, 24 of the grill hood 13a. As another alternative, grill cover 10 can include additional insulating sheets that are located between inner layer 14 and outer layer 16. Such additional insulating sheets provide a higher thermal gradient through cover 10 than cover 10 provides without the additional insulating sheets. Preferably, grill cover 10 is sized so that when panel 10 is placed on hood 13a, edges 26a and 26b are located at a lower elevation than the junction 25 between grill hood 13a and grill housing 13b at times when grill hood 13a is in the closed position.

FIG. 2B shows an alternative embodiment of the cover 10 of FIG. 2 wherein the outer panel 16 forms a boarder around inner panel 14.

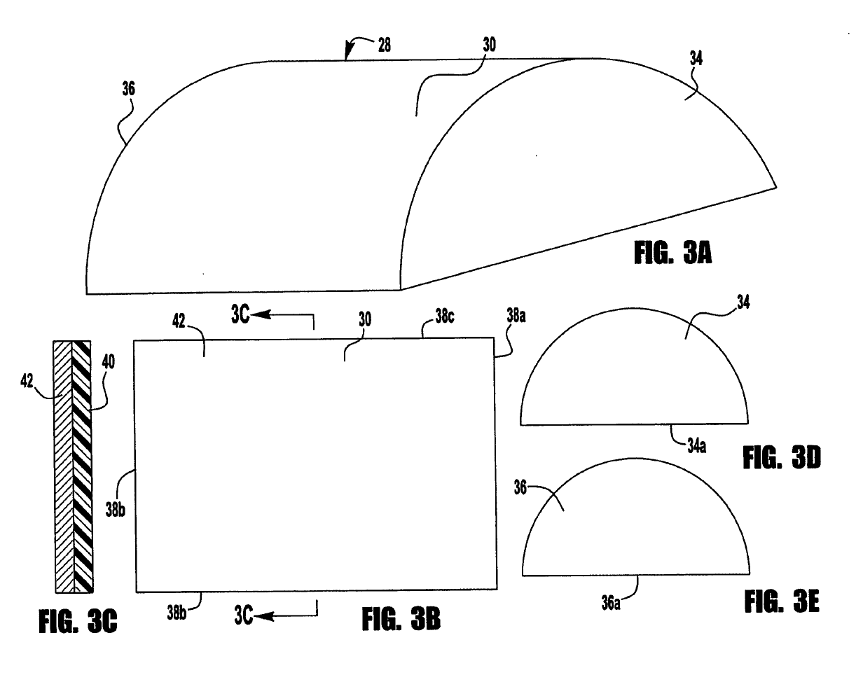

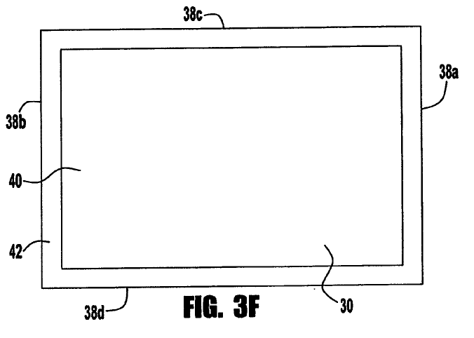

FIGS. 3A-3E show an alternative embodiment of cover 10. In FIGS. 3A-3E, a fitted cover 28 includes a flexible top panel 30 and flexible end panels 34 and 36 which are connected along one perimeter boundary to top panel 30. Panels 34 and 36 are connected to oppositely disposed edges 38a and 38b of panel 30. Fitted cover 28 is sized so that the grill to which it is applied fits between panels 34 and 36. Preferably, panel 30 and panels 34 and 36 are sized such that when the fitted cover 28 is placed on the grill, the edges 38c and 38d of panel 30 and edges 34a and 36a of panels 34 and 36 are located at an elevation below the elevation of the junction 25 formed between grill hood 13a and grill base 13b at times when grill hood 13a is in the closed position.

Similar to cover 10, fitted cover 28 includes at least one inner layer of insulating material 40 and an outer protective layer 42. Inner layer 40 may be of the same composition as inner layer 14 and alternatives and equivalents thereof and protective layer 42 may be of the same composition as protective layer 16 and alternatives and equivalents thereof. The assembly construction of inner layer 40 and protective layer 42 can be the same as the assembly construction of inner layer 14 and protective layer 16, including their alternative and equivalent assemblies.

Panels 30, 34 and 36 may be integrally connected by threaded seams or by connectors such as staples or rivets. Alternatively, panels 30, 34 and 36 can be combined in modular fashion by connecting them together with hook and loop material, fabric snaps or the equivalent thereof.

FIG. 3F shows an alternative embodiment of the cover 28 of FIGS. 3A-3E wherein the outer panel 42 forms a boarder around inner panel 40.

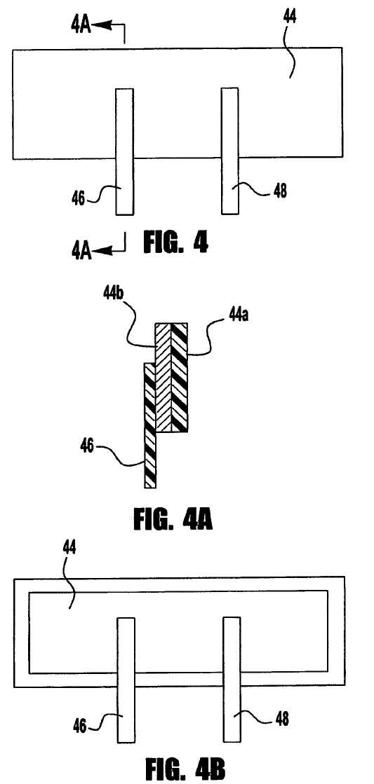

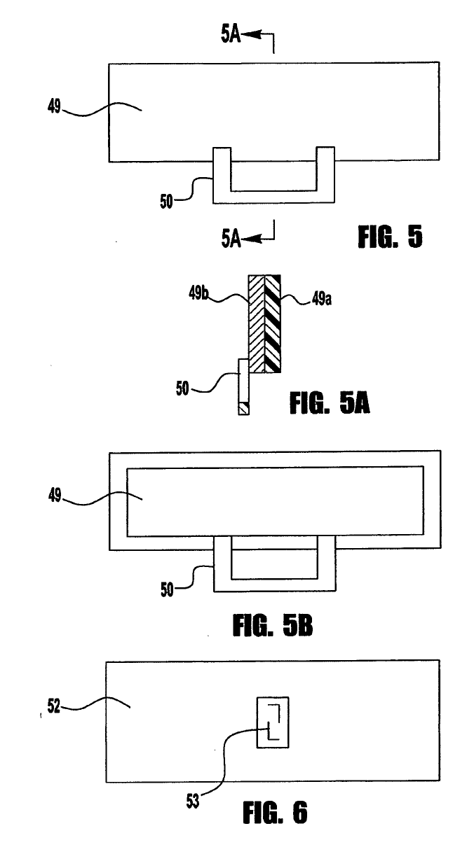

FIG. 4 shows a flat-style cover 44 that has an inner panel 44a and an outer panel 44b similar to inner panel 14 and outer panel 16 respectively. Flat-style cover 44 has two straps 46, 48 for securing the cover 44 to the handle of the grill.

The improved efficiency of the disclosed grill cover has been demonstrated in the following tests:

TEST 1
Weather Condition: Wind @5 mph or less, Temperature @20° F., grill is in the shade
Cover Material: 1 layer # AVS-FG-2025, 18 oz. plain weave fiberglass
Test Protocol:
   Grill type: 2 burner aluminum LP gas
   4×4×¼ cold rolled steel plate placed in grill with 350°, 375° and 400° F. temperature sticks placed on top of plate
   Remote temperature probed placed in grill to monitor temperature
   Test started with grill at ambient temperature
   Test run with 2 burners set on high
   Trial #1 run without cover, trial #2 run with cover
   Record elapsed time for grill to reach 500° F.

### Results:

| | Trial #2 | Trial #1 |
|---|---|---|
| | with cover | without cover |
| # Of Minutes To | 9½ | 25 (1) |
| Reach 475° F. | | |
| # Of Minutes To | 10 | N.A. (1) |
| Reach 500° F. | | |
| Improvement | 15.5 minutes | |
| With Cover | | |
| % Time Reduction | 62% | |
| With Cover | | |
| ° F./Minute | 47° | 18° |
| Temperature Rise | | |
| % Temperature Rise | 261% | |
| Improvement With | | |
| Cover | | |

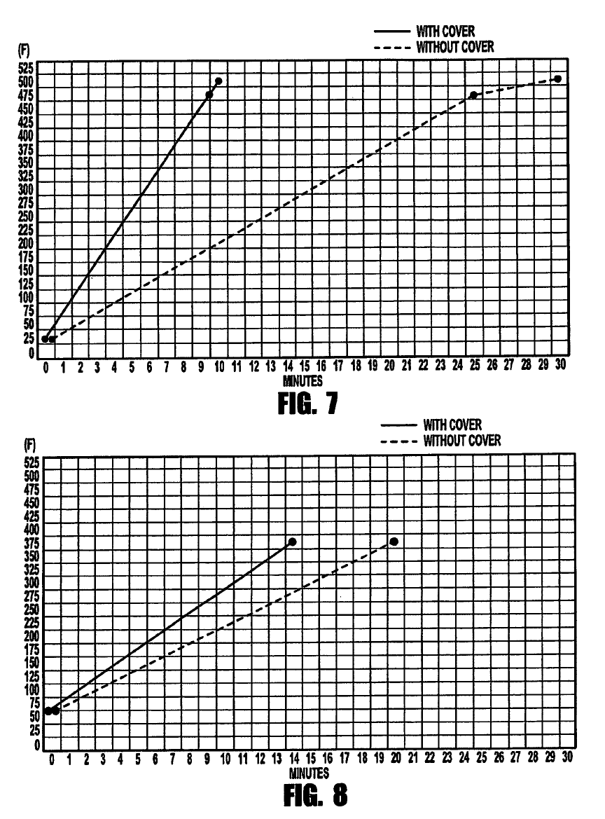

See FIG. 7 for graph of results

FIG. 4B shows an alternative embodiment of the flat style cover 44 of FIG. 4 wherein the outer panel 44b forms a boarder around inner panel 44a.

FIG. 5 shows a flat-style cover 49 with an inner panel and an outer panel similar to inner panel 14 and outer panel 16 respectively of cover 10. Cover 49 further includes a handle 50 that may be permanently or removeably fastened to the inner and outer panels in the manner of the connection of strap 18 to protective layer 16, including alternatives and equivalents thereof.

FIG. 5B shows an alternative embodiment of the flat style cover 49 of FIGS. 5 and 5A wherein the outer panel 49b forms a boarder around inner panel 49a.

FIG. 6 shows a flat-style cover 52 that has a window 54 that allows an operator to view gauges such as a temperature gauge.

FIGS. 12 and 13 show an alternative embodiment of a grill cover 60 wherein an extended section of the cover extends between the grill hood 13a and handle 20 such that the cover shields a human operator from inadvertently touching the grill hood while holding handle 20. Specifically, In FIGS. 12 and 13, cover 60 defines a perimeter shape wherein two short sides 62, 64 are generally parallel to each other. The perimeter of cover 60 also has two longer sides 66, 68 that are located between the short sides 62, 64. One end of longer side 66 joins a first end of short side 62 and the opposite end of longer side 66 joins a first end of short side 64. Correspondingly, one end of longer side 68 joins a second end of short side 62 and the opposite end of longer side 68 joins a second end of short side 64.

In the embodiment of FIGS. 12 and 13, at least one of the longer sides 66, 68 defines the outer boundary of an extension section 70. Extension section 70 is defined by the area of cover 60 between the longer side 66 and a straight line 72 between the intersection of one end of side 66 and short side 62 and the intersection of the other end of side 66 and short side 64. In this way, extension section 70 protrudes from the main body of cover 60.

When grill cover 60 is applied to a grill as shown in FIG. 13, extension section 70 extends between the grill hood 13a and handle 20 to shield an operator from touching the grill hood while lifting and lowering grill hood 13a. Preferably, cover 60 includes a strap 72 that a hook-and-loop material or other fastener so that strap 72 can be attached to handle 20 to help retain cover 60 in place on the grill hood 13a, particularly at times when the grill hood is raised.
(1) Maximum Temperature achieved and held steady without cover. Added cover and in 5 minutes grill temperature rose to 504° F. and held steady.
   All three temperature sticks melted in both tests.

TEST 2
Weather Condition: Wind @5 mph or less, Temperature @60° F., grill in full sun
Cover Material: Sewn assembly of 1 layer # AVS-FG-2025, 18 oz. plain weave fiberglass and 1 layer of #1715-2 Sil Rub

### Test Protocol:

Grill type: 6 burner stainless steel LP gas
Remote temperature probe placed in center of grill on upper rack
2 burners directly under probe are not used
Test started with grill and probe at ambient temperature
Test run with 2 intermediate burners set on high
Trial #3 run without cover, trial #4 run with cover
Record elapsed time for grill to reach 375° F.

### Results:

| | Trial #3 | Trial #4 |
|---|---|---|
| | with cover | without cover |
| # Of Minutes To | 14 | 20 |
| Reach 375° F. | | |
| Improvement | 6 minutes | |
| With Cover | | |
| % Time Reduction | 30% | |
| With Cover | | |
| ° F./Minute | 23° | 16° |
| Temperature Rise | | |
| % Temperature Rise | 144% | |
| Improvement With | | |
| Cover | | |

See FIG. 8 for graph of results

TEST 3
Weather Condition: Wind @5 mph or less, Temperature @75° F., grill in full sun
Cover Material: Sewn assembly of 1 layer # AVS-FG-2025, 18 oz. plain weave fiberglass and 1 layer of #1715-2 Sil Rub

### Test Protocol:

Grill type: 6 burner stainless steel LP gas
Remote temperature probe placed in center of grill on upper rack
2 burners directly under probe are not used
Test started with grill and probe at ambient temperature
Test run with 2 intermediate and 2 outer burners set on high
Trial #5 run with cover, trial #6 run without cover
Record elapsed time for grill to reach 375° F.

### Results:

| | Trial #5 | Trial #6 |
|---|---|---|
| | with cover | without cover |
| # Of Minutes To | 5½ | 7 |
| Reach 375° F. | | |
| Improvement | 1/½ minutes | |
| With Cover | | |
| % Time Reduction | 21% | |
| With Cover | | |
| ° F./Minute | 56° | 43° |
| Temperature Rise | | |
| % Temperature Rise | 130% | |
| Improvement With | | |
| Cover | | |

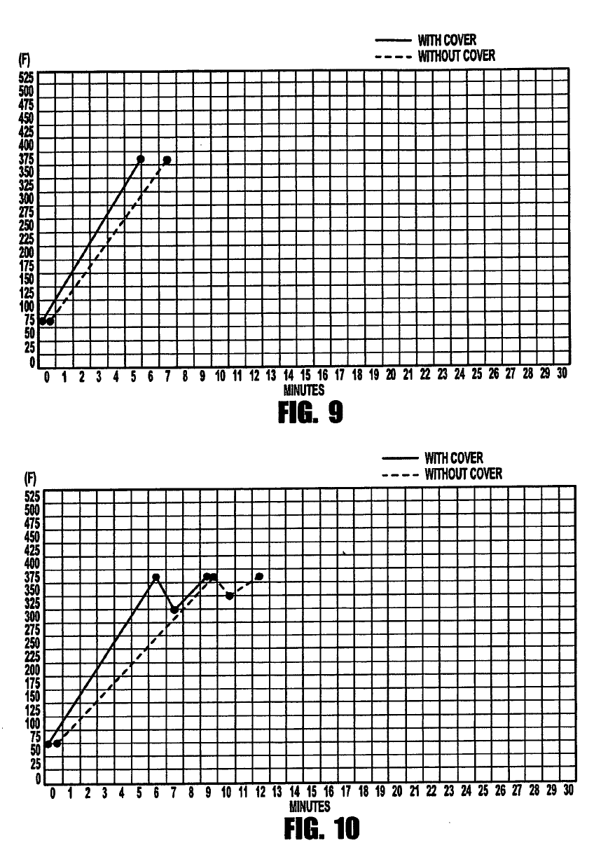

See FIG. 9 for graph of results

TEST 4
Weather Condition: Wind @10-15 mph, Temperature @65° F., grill in full sun
Cover Material: Sewn assembly of 1 layer # AVS-FG-2025, 18 oz. plain weave fiberglass and 1 layer of #1715-2 Sil Rub

### Test Protocol:

Grill type: 6 burner stainless steel LP gas
Remote temperature probe placed in center of grill on upper rack
2 burners directly under probe are not used
Test started with grill and probe at ambient temperature
Test run with 2 intermediate and 2 outer burners set on high
Trial #7 run with cover, trial #8 run without cover
Record elapsed time for grill to reach 375° F.
Record time to reach 375° F. after grill is open for 45 seconds

### Results:

| | Trial #7 | Trial #8 |
|---|---|---|
| | with cover | without cover |
| # Of Minutes To | 6 | 9 |
| Reach 375° F. | | |
| Improvement | 3 minutes | |
| With Cover | | |
| % Time Reduction | 33% | |
| With Cover | | |
| ° F./Minute | 52° | 34° |
| Temperature Rise | | |
| % Temperature Rise | 153% | |
| Improvement With | | |
| Cover | | |
| ° F. Drop | 65° | 30° |
| With Grill Open | | |
| Minutes Recovery to | 2 | 2 |
| 375° F. | | |
| ° F./Minute | 33° | 15° |
| Recovery Rate | | |
| % Recover Rate | 220% | |
| Improvement | | |
| With Cover | | |

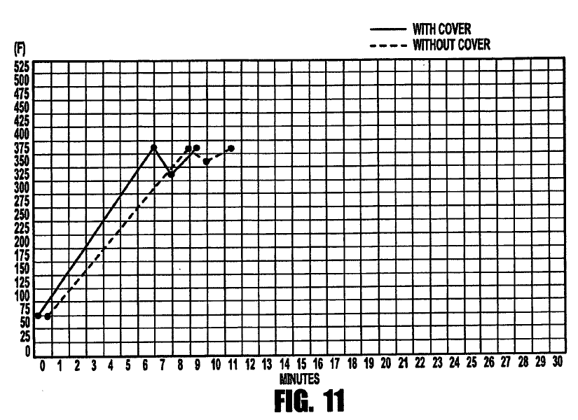

See FIG. 10 for graph of results

TEST 5
Weather Condition: Wind @10-15 mph, Temperature @65° F., grill in full sun
Cover Material: Sewn assembly of 1 layer # AVS-FG-2025, 18 oz. plain weave fiberglass and 1 layer of #1715-2 Sil Rub

### Test Protocol:

Grill type: 6 burner stainless steel LP gas
Remote temperature probe placed in center of grill on upper rack
2 burners directly under probe are not used
Test started with grill and probe at ambient temperature
Test run with 2 intermediate and 2 outer burners set on high
Trial #9 run with cover, trial #10 run without cover
Record elapsed time for grill to reach 375° F.

### Results:

| | Trial #9 | Trial #10 |
|---|---|---|
| | with cover | without cover |
| # Of Minutes To | 6½ | 8½ |
| Reach 375° F. | | |
| Improvement | 2 minutes | |
| With Cover | | |
| % Time Reduction | 24% | |
| With Cover | | |
| ° F./Minute | 47° | 36° |
| Temperature Rise | | |
| % Temperature Rise | 131% | |
| Improvement With | | |
| Cover | | |
| ° F. Drop | 50° | 25° |
| With Grill Open | | |
| Minutes Recovery to | 1½ | 1½ |
| 375° F. | | |
| ° F./Minute | 33° | 17° |
| Recovery Rate | | |
| % Recover Rate | 165% | |
| Improvement | | |
| With Cover | | |

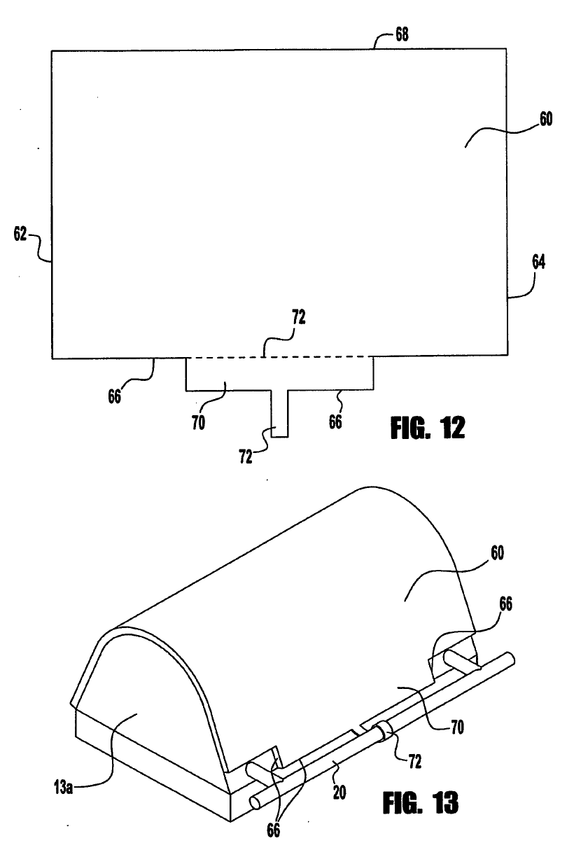

See FIG. 11 for graph of results

I claim:

1. A cover for outdoor grills, said cover comprising:
at least one layer of insulating material; and
an outer layer of protective material that is secured to the layer of insulating material and that is selected from the group comprising aluminum, silicone rubber, vinyl, and canvas.

2. The cover of claim 1 further comprising at least one strap for attaching the cover to the grill.

3. The cover of claim 2 wherein said grill has a handle and wherein said strap is connected to the handle of the grill.

4. The cover of claim 3 wherein said strap is comprised of material selected from the group consisting of fiberglass, hook and loop material, leather, and rope.

5. The cover of claim 1 wherein said cover further includes a window, said window being located on said cover to coincide with the location of a gauge on said grill so that the gauge can be viewed at times when the cover is applied to the grill.

5. The cover of claim 1 wherein the time period from when the grill is ignited until the grill reaches a given temperature inside the grill is within the range of 20% to 65% lower at times when the cover is applied to the grill than at times when the grill is without the cover.

6. The cover of claim 5 wherein the rate of temperature increase inside the grill from the time of grill ignition when the cover is applied to the grill is within the range of 130% to 261% faster than when the cover is absent from the grill.

7. The cover of claim 5 wherein the grill has been opened after the grill has been operating, the rate of temperature increase inside the grill from the time when the grill is reclosed is within the range of 165% to 220% faster when the cover is applied to the grill than when the cover is absent from the grill.

8. The cover of claim 1 wherein said outdoor grill includes a base and a hood that is pivotally connected to said base and that forms a junction with said base at times when said hood is in a closed position and wherein said at least a layer of fiberglass insulation material extends over and covers said junction between said base and said hood.

9. The cover of claim 1 wherein said insulating material is fiberglass.

10. The cover of claim 9 wherein said protective material is aluminum.

11. The cover of claim 10 wherein said layer of fiberglass insulating material is bonded to the outer layer of aluminum protective material with an adhesive.

12. The cover of claim 1 wherein said grill includes a hood that has a handle that extends away from said hood, said cover having an extension section that is located between said handle and said hood at times when said cover is placed over said hood.

13. The cover of claim 12 wherein said cover defines a shape having two short sides that are generally parallel to each other and also have two longer sides that are located between said shorter sides, at least one of said longer sides defining the extension section that extends between the handle and the hood.
